(19) United States
(12) Patent Application Publication
(10) Pub. No.: US 2005/0125515 A1
(43) Pub. Date: Jun. 9, 2005

(54) Method and system for verifying managed object status before update

(76) Inventors: Daniel Dufour, Blainville (CA); Andre Godin, Laval (CA)

Correspondence Address: Alex Nicolaescu, 8400 Decarie Bld, QA3096, Montreal, QC, H4P 2N2, CA

(21) Appl. No.: 10/729,469

(22) Filed: Dec. 6, 2003

(51) Int. Cl. G06F 15/177

(52) U.S. Cl. 709/221

(57) ABSTRACT

A method and manager node is provided for verifying status information of Managed Objects (MOs) of a management system before propagating an update to a managed network. Subsequent to an attribute change of a given MO in the manager, the manager detects other MOs related to the updated MO, such as neighbour radio cells of a given radio cell. The manager obtains status information relative to each related MO, such as synchronization information, connection information or coupling information. If the status information is adequate for pursuing the update, the manager propagates the update to the managed network. Otherwise, the manager issues a warning to the system administrator, and only propagates the change to the managed network when confirmed by the systems administrator.

### BACKGROUND OF THE INVENTION

1. Field of the Invention

The present invention relates to a method and system for verifying Managed Object (MO) status before updating a managed network.

2. Description of the Related Art

Management systems are well known in the art. They are used for monitoring and managing the quality of communications over various networks, such as for example Local Area Networks (LANs), Wide Area Networks (WANs), Public Local Mobile Networks (PLMNs), and Public Switching Telephone Networks (PSTNs), hereinafter designated as the managed or monitored networks. Exemplary functions of a typical management system comprise, but are not limited to, providing configuration and status information about Network Elements (NEs) or NEs' components, collecting alarm/event notifications, correlating the alarm/event notifications with each other, diagnosing and repairing errors and malfunctions. In such systems, pieces of information called events (or event notifications or alarms) are issued by the NEs of the managed network and acquired by the management system, which is responsible of their treatment. The information issued by the processing of the alarm/event notifications may be monitored, either automatically or by system administrators, with the general purpose of maintaining or increasing the quality of the communications of the managed network. On the other side, another function of the management system comprises updating configuration attributes related to the managed network's elements using a user interface, and deploying the updates toward the managed network's elements.

Reference is now made to FIG. 1 (Prior Art), which is a high-level network diagram of a management system 100 which function is to manage a Public Local Mobile Network (PLMN) 102. The PLMN 102 may comprise, as it is well known in the art, a plurality of base stations 104-107, which provide cellular radio service to a plurality of mobile stations 108-119 via associated radio interfaces. The base stations 104-107 are connected to a Base Station Controller 1 (BSC 1) 120, which in turn connects to a Mobile Switching Center 1 (MSC 1) 122. The PLMN 102 may further comprise a second MSC, called MSC 2 124, and a second BSC, called BSC 2 126, as well as a Gateway GPRS Support Node (GGSN) 127, a Serving GPRS Support Node (SGSN) 128 and an associated Base Station Subsystem (BSS) 130. According to the exemplary PLMN 102 shown in FIG. 1, each Network Element (NE) of the managed network (the PLMN 102), comprises a management Agent (Agent 1 to Agent 7) responsible for maintaining management information about the NE that stores it. The management information of each Agent may comprise configuration and status information about the particular NE and its components and connections. Each such NE Agent connects via management links 111 (shown in double line) to a Manager 160 of the management system 100, which function is to collect events and alarm notifications 150, 152, and 154 issued by the NEs' Agents 1-7 121, 123, 125, 127, 129, 131, and 133 of the managed system 102. The Manager 160 receives the alarm and events notifications 150, 152, and 154 from the monitored system 102 and may further process, correlate, and adapts the received information into a format compatible and suitable for viewing by a variety of system administrators' terminals 162-168 of the management system 100. A further function of the Manager 160 is to allow for the updating of configuration attributes related to any one or more of the managed NEs, using the terminals 162-168, and to deploy the updated attributes to the NEs, such as shown in the exemplary actions 180, 182, 184.

In a typical management system, the management information stored in the Manager 160 comprises virtual entities known as Managed Objects (MOs), which are virtual representations of the managed network's Network Elements (NEs), or NEs' components. For example, the NE BSC 1 120 is represented in the Manager 160 as an MO. Furthermore, the NE BSC 1 120 may comprise a plurality of NE components, such as for example radio controllers 170-179, which are also represented in the Manager 160 as a corresponding plurality of MOs 170′-179′, that depend upon the high level MO corresponding to BSC 1 120.

Such a virtual representation of each NE and NE component of the managed network 102 allows system administrators of terminals 162-168 to be able to view and edit the related attributes of each MO, which updates are then deployed as configuration attributes to corresponding NEs in the managed network 102. In this manner, system administrators are able to monitor and improve the quality of the communications of the managed network 102.

Reference is now made to FIG. 2 (Prior Art), which shows a high-level block diagram of a management Agent of an NE of a managed network, such as for example of the Agent 121 of the NE BSC 1 120, previously described with reference to FIG. 1. The Agent 121 is a functionality of the NE BSC 1 120, which function is to store configuration and status information regarding the functioning of the NE BSC 1 120, its components and connections. For this purpose, the Agent 1 121 comprises a Management Information Base (MIB) 200, which may comprise any kind of memory or database that stores local management information about the NE BSC 1 120. For example, the MIB 200 may store a list of a plurality of components 202-206 of the BSC 1 120, along with their associated status information 208 and attribute values 210-214. The MIB 200 may further store a list of connections 216-220 of the BSC 1 120, along with their corresponding status 222, and attribute values 224-228.

While the NEs of the managed network 102, such as the BSC 1 120 (shown in FIG. 1) comprise an Agent with a MIB for storing only local configuration and status information, the Manager 160 is in charge of managing the entire managed network 102 and therefore comprises its own MIB that stores management information about each one of the managed NEs of the managed network. The Managers information typically takes the form of Managed Objects (MOs). In most situations, the Manager 160 maintains a Master-Slave relationship with the plurality of NE of the managed network, so that every configuration and status update that is performed in the management information stored in the Manager is propagated into the corresponding NE(s) of the managed network 102, and has precedence over any local configuration or status parameter of thauthose NE(s).

Reference is now made to FIG. 3 (Prior Art) that is a high-level block diagram of a Manager alike the Manager 160. The Manager 160 comprises its own MIB 300 storing, for example, a first MO 302 with a MIB relative to the Agent 1 121 of the NE BSC 1 120, and a second MO 304 with a MIB relative to the Agent 2 127 of the BSC 2 126. Each such MIB comprises management information 306 and 308 relative to the appropriate Agent of the managed network, and a synchronization status 310 and 312 indicative of a current status of synchronization between the given MO of the Manager 160 and its corresponding NE's MIB from the managed network. For example, the synchronization status 310 of the MO 302 may be “In SYNCH”, which is indicative that the management information 306 of the MO 302 stored in the Manager 160 is currently synchronized with the management information stored in the MIB 200 of the Agent 1 121 of the NE BSC 1 120 (Agent 121 is shown in FIG. 2). This normally happens once an update of configuration and/or status information regarding the Agent is successfully propagated from the Manager 160 to the Agent 121 in the managed network, so that the management information of the MIB 200 of the NE is synchronized with the management information of the MIB 302 of the Manager 160.

However, it has been noticed that in various instances it is not sufficient to have a perfect synchronization between the management information relative to a given MO of the Manager and its corresponding NE of the managed network. For example, updates of an MO's attributes performed in the Manager's MIB may not only need to be propagated to the corresponding NE, but also to other NEs of the managed network. An instance wherein this situation occurs is, for example, when a system administrator updates a radio channel attribute relative to a component (e.g. a radio cell) of the MO 302 that represents the NE BSC 1 120 of the managed network. Since a radio channel attribute has been changed, such change not only affects the corresponding NE BSC 1 120 but also its neighbour BSC that controls the cells that are adjacent to the radio cell which radio channel attribute has been changed. In the present exemplary scenario, it is assumed that the NE BSC 2 126 is the BSC that controls a neighbouring radio cell of the given cell, and therefore, the update of the radio channel attribute needs also to be propagated to the NE BSC 2 126 (better shown in FIG. 1).

Another problem arises when a system administrator desires to update an attribute of a certain MO of the management system, and when such MO, or a related NE to which that update also needs to be propagated is not perfectly synchronised with the management system. Current management systems fail to take into consideration the status of related NEs (or MOs) in propagating a new update. This may generate even further inconsistencies between the management information stored in the management system and the one deployed in the managed network.

Although there is no prior art solution as the one proposed hereinafter for solving the above-mentioned deficiencies, the U.S. Pat. No. 6,041,342 issued to Yamaguchi on Mar. 21, 2000 (hereinafter called Yamaguchi) bears some relation with the field of the present invention. Yamaguchi teaches a synchronization process between a management station and an agent station, wherein responsive to an execution request message sent from the management station to the agent station, the latter estimates the time required for execution of a synchronization and informs the management station. At the expiration of the time period, the management station inquires about the status of the synchronization, and receives another time estimate from the agent station. If the time estimate is zero, the management station concludes that the synchronization process is completed. Otherwise, the management station waits for the length of the second time estimate, and concludes the synchronization process at its expiration.

Yamaguchi only deals with a process for limiting the time required for a synchronization of a management station with an agent station. Therefore, Yamaguchi fails to teach or suggest a method and system for synchronization status information of a manager's MO based on synchronization between the manager and multiple agents.

The US Patent Application U.S. 2002/0120733 published in the name of Kring on Aug. 29, 2002 (hereinafter called Kring) also bears some relation with the field of the present invention. Kring teaches a method, program, and system for synchronizing a network manager with an agent, wherein the agent stores three different values. The first value is unique, the second value indicates the number of changes performed to the associated data unit, while the third value indicates the identity of the initiator of the last change to the data unit. A copy of the three values is also stored in the manager and is compared with the agent's three values. When the agent and manager's values do not match, the three values of the manager are synchronized with the three values of the agent.

The teaching of Kring is limited to synchronizing three different values between one agent and one manager. Hence, Kring also fails to teach or suggest a method and system for synchronization status information of a manager's MO based on synchronization between the manager and multiple agents.

Accordingly, it should be readily appreciated that in order to overcome the deficiencies and shortcomings of the existing solutions, it would be advantageous to have a method and system for effectively allowing the synchronization of a manager's MIB based on synchronization processes with multiple agents.

### SUMMARY OF THE INVENTION

In one aspect, the present invention is a A method for verifying status information of one or more Managed Objects (MOs) of a management system, the method comprising the steps of:
a. changing an attribute of a management system's first MO that represents a first Network Element (NE) of a managed network;
b. responsive to the attribute change, determining one or more MOs related to the first MO;
c. obtaining status information relative to each one of the one or more related MOs; and
d. if the status information relative to any one of the one or more related MOs is not compatible with a propagation of the attribute change to the managed network, issuing a warning message.

In another aspect, the invention is a manager of a management system comprising:
a first Management Object (MO) that represents a first Network Element (NE) of a managed network;
a second MO that represents a second NE of the managed network, the first and the second NEs being related Nes;
wherein when an attribute of the first MO is changed in the manager, the manager determines one or more MOs related to the first MO, obtains status information relative to each one of the one or more related MOs and, if the status information relative to any one of the one or more related MOs is not compatible with a propagation of the attribute change to the managed network, the manager issues a warning message.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram of a typical management system that manages a Public Local Mobile Network (PLMN);

FIG. 2 (Prior Art) is a high-level block diagram of a typical management Agent of a Network Element (NE) of a managed network;

FIG. 3 (Prior Art) is a high-level block diagram of a typical Manager of a management system; and

FIG. 4 is an exemplary high-level representation of two neighbouring NEs of a managed network;

FIG. 5 is an exemplary high-level block diagram of a Manager that manages two different NEs according to the preferred embodiment of the present invention;

FIG. 6 is an exemplary high-level block diagram of a Managed Object (MO); and

FIG. 7 is an exemplary flowchart diagram of a method according to the preferred embodiment of the present invention.

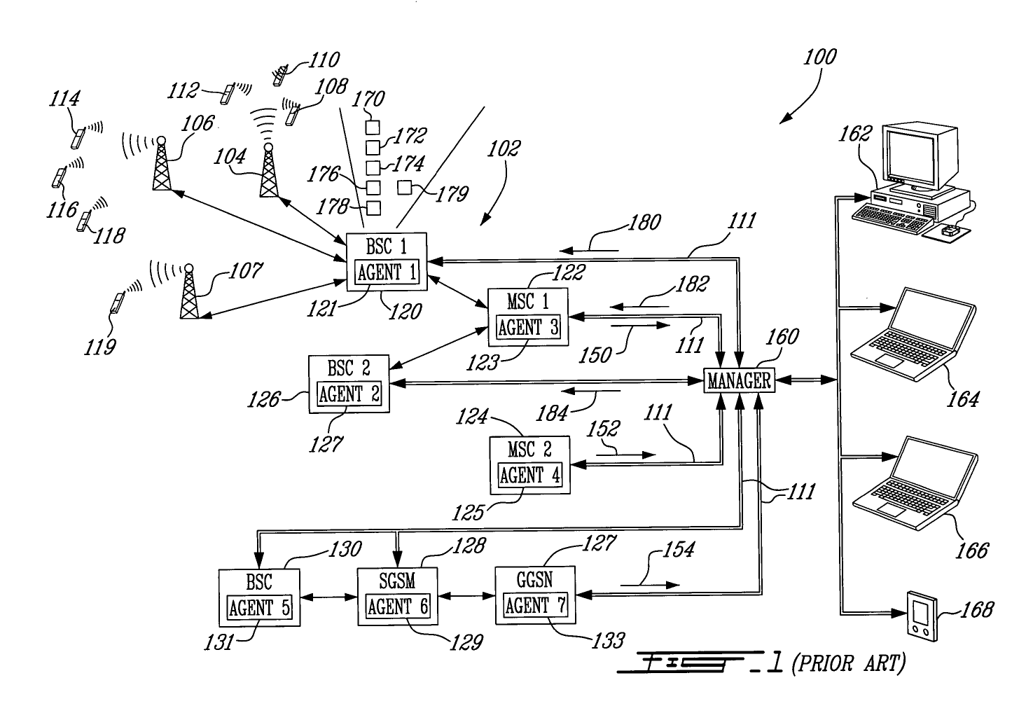

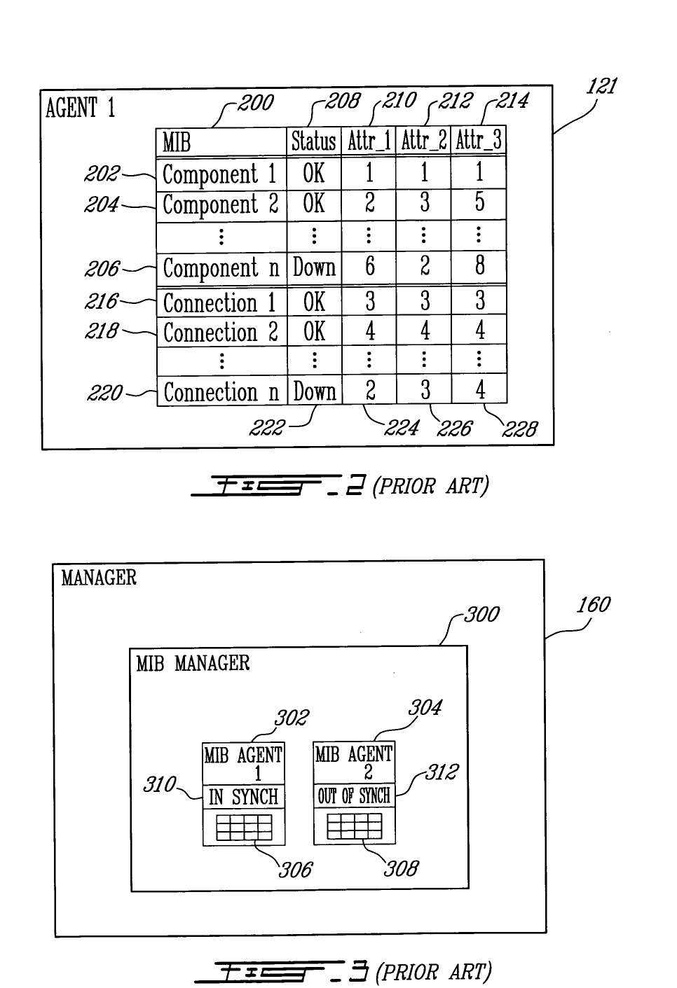

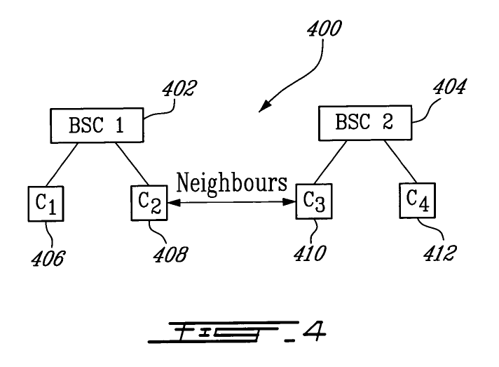

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and system for verifying a status of all the Managed Objects (MOs) that relate to one given MO that needs to be updated in a management system, before deploying the update toward the Network Elements (NEs) of the managed network. When a given MO's attributes are updated in a Manager of a management system, the invention allows for the status of all related MOs to be first verified, and if compatible with the update, then the change is propagated to all the concerned, or related NEs.

In order to better understand the present invention, once should first appreciate that instances occur in a management system wherein a change of a given attribute of a given MO that is performed in the Manager may not only affect the managed network's NE corresponding to the given MO, herein called the corresponding NE, but also other NE(s) of the managed network, herein called the related NE(s).

For example, reference is now made to FIG. 4 that shows a high-level representation of two neighboring NEs of a managed network, which in the present exemplary scenario is assumed to be a Public Local Mobile Network (PLMN) 400. Shown in FIG. 4 are two (2) Base Station Controllers (BSCs), BSC 1 402 and BSC 2 404, and four (4) radio cells identified C1-C4 (406-412), although it is understood that many more NEs of the PLMN 400 may exist. It is further assumed that the radio cell C2 408 and the radio cell C3 410 are adjacent (neighbors) in the PLMN 400, so that a Mobile Station (MS) can perform a hand-off from one to the other. In such an instance, changes performed to radio attributes of one such cell also affect the other radio cell since, for example, when performing a hand-off from one cell to the other, the target cell must know and also take into consideration the other cell's radio attributes. Hence, when a system administrator updates, for example, a radio attribute relative to an MO representative of radio cell of the PLMC 400, this change needs not only to be propagated to the corresponding radio cell (the corresponding NE), but also to all its neighbor radio cells (the related NEs).

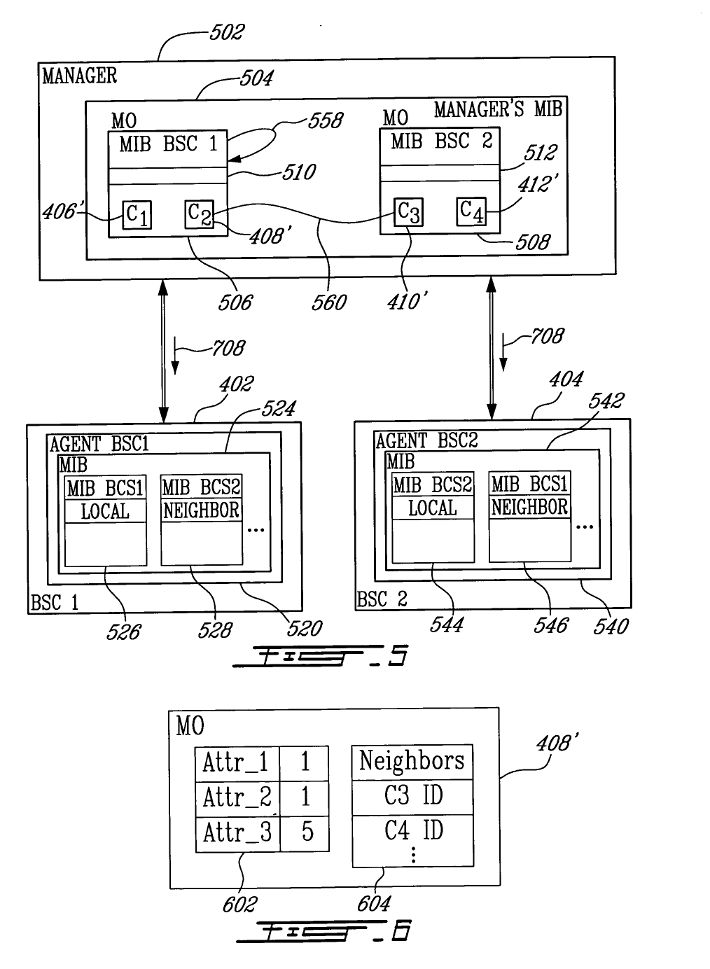

Reference is now made to FIG. 5 which is an exemplary high-level block diagram of a Manager 502 that manages two different NEs 402 and 404 according to the preferred embodiment of the present invention. It is understood that a typical Manager typically comprises many more MOs than the ones shown in FIG. 5. The Manager 502 may be part of a management system (not shown), and comprises a Management Information Base (MIB) 504 for storing management information, including status and configuration information, relative to MOs representative of NEs of the managed network. For example, illustrated in FIG. 5 within the MIB 504 are MOs 506 and 508 that are virtual representations of the NEs BSC 1 402 and BSC 2 404 of the managed network. Each MO of the Manager's MIB 504 comprises status information 510 and 512 respectively, such as for example synchronization status information, which is indicative of a synchronization status between the MO and its corresponding NE. For example, when the management information of the MO 506 is synchronized with the management information of its corresponding NE BSC 1 402, the synchronization status 510 of the MO 506 is set to “IN SYNCH”.

Some MOs of the Manager's MIB 504 may also comprise one or more components that may be representative of sub-elements comprised in their corresponding NEs of the managed network. For example, MO 506 may comprise components C1 406′ and C2 408′ representative of the radio cells 406 and 408 respectively that were previously discussed with reference to FIG. 4. Likewise, MO 508 may also comprise components C3 410′ and C4 412′ representative of the radio cells 410 and 412 respectively.

With further reference being made to FIG. 5, at the managed network level are represented the first NE BSC 1 402 and the second NE BSC 2 404, which are assumed to be neighbour BSCs in the PLMN 400, as previously described. The first NE BSC 1 402 comprises its own management Agent 520 responsible for managing and storing management information relative to the BSC 1 402. For this purpose, the Agent 502 comprises its own MIB 524 that may in turn include a local MIB branch 526 with local information relative to the BSC 1 402 itself, such as for example with local configuration information, connections with external NEs, local status information, etc. The MIB 524 may further comprise one or more neighbour NE MIB branch(es) for storing similar management information as the one stored in the local MIB 526, except for the fact that it relates to neighbour NEs, such as for example to the neighbour NE 404. Similarly, the NE BSC 2 404 also comprises its own Agent 540 including its own MIB 542 with a local MIB branch 544 and a neighbour MIB branch 546, relative to the neighbour BSC 1 402.

Because the radio cells 408 and 410 (better shown in FIG. 4) are neighbour NEs in the managed network, so are NEs 402 and 404 too, and hence their virtual representations, i.e. the MOs 506 and 508 of the Manager 502 are also associated as neighbour MOs inside the MIB 504 as well, via association link 560. Such an association link may comprise a reference in the management information of component C2 408′ that refers to fact that the radio cells C3 410 and C4 412 neighbours the radio cell C2 408.

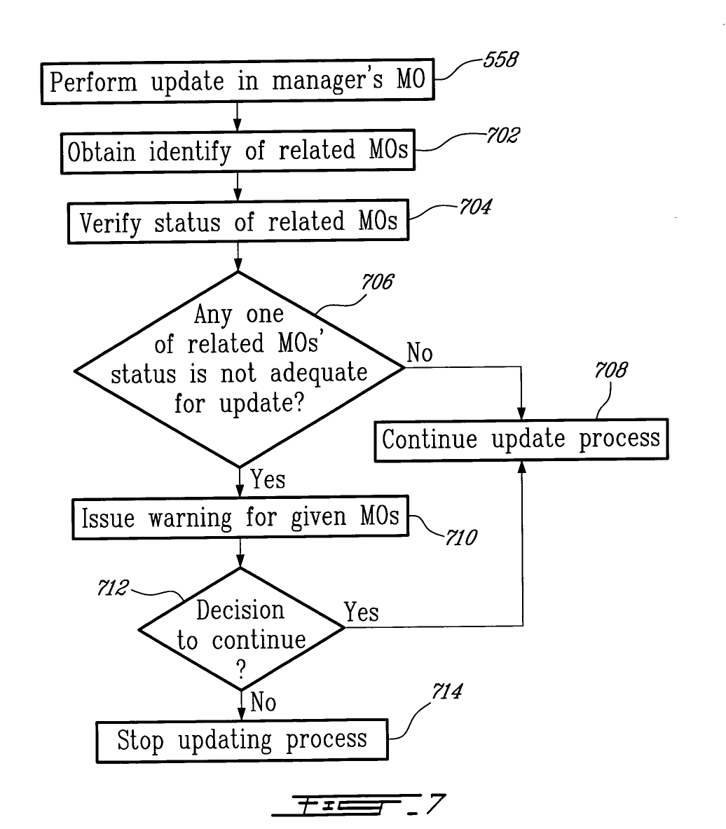

Reference is now made to FIG. 6 which is an exemplary high-level block diagram of the MO 408′ that corresponds to the radio cell C2. Shown in FIG. 6 is the MO 408′ that comprises a list 602 of attributes, as well as a list 604 of neighbour components, For example, the list 604 may indicate that radio cells C3 and C4 are cells that neighbour the radio cell C2.

Reference is now made concomitantly to FIGS. 5, 6 and to FIG. 7, which is a high-level flowchart diagram illustrative of the method of the preferred embodiment of the invention, wherein the functioning of the Manager 502 and the method of operating such Manager is to be described. First, a system administrator performs an update of a given attribute of the MO 506, action 558. In action 702, the Manager 502 obtains the identities of all the MOs that are related to the updated MO. By “related” it is understood those MOs which correspondent NEs are to deploy the change effectuated by the system administrator. The related MOs may comprise neighbor MOs or any other type of associated MOs. For example, for performing action 702, the Manager 502 may scan each component of the updated MO, such as components C1 406′ and C2 408′, and look into their neighbor list and identify the related MOs. For example, by looking into the neighbor list 604 of the MO 408′, the Manager 502 identifies that cell C3 and cell C4 are related to the updated MO 506 because they neighbor cell C2 that is a component of the updated MO.

Next, in action 704, the Manager 502 obtains and verifies the status of each one of the identified MOs. Such status information that is obtained and verified in action 704 may comprise:
synchronization status information. Such status may be “IN SYNCH”, showing a perfect synchronization between the given MO of the Manager and its correspondent NE of the managed network, or “OUT-OF-SYNCH”, which shows that the synchronization between the given MO of the Manager and its correspondent NE of the managed network is not perfect.
Couple status information. Such status may be “COUPLED”, showing that for a given MO of the Manager there exists a correspondent NE of the managed network, or “UNCOUPLED”, which shows that only the given MO of the Manager exists, but its correspondent NE has not been yet installed in the managed network or is otherwise not existent.
Connected status information. Such status may be “CONNECTED”, showing that a given MO of the Manager is logically connected to its a correspondent NE of the managed network, or “UNCONNECTED”, which shows that the given MO of the Manager is not logically connected to its correspondent NE of the managed network.

In action 706, the Manager 502 detects if any one of the identified related MOs has status information that is not adequate for pursuing with the update process. By this, it is understood that the Manager 502 detects if any identified MO has synchronization status information that is “OUT-OF-SYNCH”, or any couple status information that is “UNCOUPLED”, or any connected status information that is “UNCONNECTED”. If not, i.e. if all the related MOs' status information is compatible with pursuing the update process, in action 708 the update process is continued and the change performed by the system administrator is propagated to the NEs that correspond to the identified MOs. Otherwise, if in action 706 any one of the evaluated status information is not adequate for an update, such as for example if the synchronization status of MO 508 that comprises the component C3 representative of the neighbor cell 3 is “OUT-OF-SYCNH”, the Manager 502 issues a warning message for the system administrator, informing of the problematic status of the given MO 508, action 710. In action 712, the system administrator may decide to still go ahead with the propagation of the change toward the managed system (the affirmative case of action 712), in which case the update process continues, action 708. If the system administrator decides to abandon the propagation of the change toward the managed system (the negative case of action 712), then the update process is stopped, action 714.

Based upon the foregoing, it should now be apparent to those of ordinary skills in the art that the present invention provides an advantageous solution, which allows for a verification of the status information of multiple related MOs of a Manager prior to deploying an update toward NEs of the managed network. It should be realized upon reference hereto that the innovative teachings contained herein may be implemented advantageously with any applicable radio telecommunications standard for a managed network. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow. For example, although the exemplary scenarios illustrated herein make reference to only two MOs and NEs, it is understood that the invention can be applied to any given number of MOs and NEs of a management system and managed network. Furthermore, although the invention was described as applicable to a scenario wherein the related NEs are neighboring elements of a PLMN, it is apparent that the nature of the NE, as well as the relation/association between the NEs that need to be updated following a change in a given MO, is not limited thereto. For example, the related NEs may be Personal Computer (PCs) or servers of a Local Area Network (LAN), and their relation may be that of cooperating nodes, or a master-slave relation, or any other type of relationship wherein a change performed to attributes of one node also needs to be propagated into another node.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for verifying status information of one or more Managed Objects (MOs) of a management system, the method comprising the steps of:
a. changing an attribute of a management system's first MO that represents a first Network Element (NE) of a managed network;
b. responsive to the attribute change, determining one or more MOs related to the first MO;
c. obtaining status information relative to each one of the one or more related MOs; and
d. if the status information relative to any one of the one or more related MOs is not compatible with a propagation of the attribute change to the managed network, issuing a warning message.

2. A manager of a management system comprising:
a first Management Object (MO) that represents a first Network Element (NE) of a managed network;
a second MO that represents a second NE of the managed network, the first and the second NEs being related NEs;
wherein when an attribute of the first MO is changed in the manager, the manager determines one or more MOs related to the first MO, obtains status information relative to each one of the one or more related MOs and, if the status information relative to any one of the one or more related MOs is not compatible with a propagation of the attribute change to the managed network, the manager issues a warning message.
